(19) United States
(12) Patent Application Publication
(10) Pub. No.: US 2013/0184987 A1
(43) Pub. Date: Jul. 18, 2013

(54) GENERATION OF PROXIMITY INFORMATION

(71) Applicant: Cartasite, Inc., Denver, CO (US)

(72) Inventors: David Lansdell Armitage, Golden, CO (US); Mark Alvin Mason, Thornton, CO (US)

(73) Assignee: Cartasite, Inc., Denver, CO (US)

(21) Appl. No.: 13/739,460

(22) Filed: Jan. 11, 2013

Related U.S. Application Data
(60) Provisional application No. 61/586,358, filed on Jan. 13, 2012.

(51) Int. Cl. G01C 21/32

(52) U.S. Cl. CPC G01C 21/32
USPC 701/454

(57) ABSTRACT

The present disclosure relates to generating proximity information. The method includes receiving and processing location information. The location information is then processed. The processed location information is then used to generate proximity information.

### CROSS REFERENCE TO RELATED APPLICATIONS

This application claims priority to, and benefit from, provisional patent application Ser. No. 61/586,358, entitled “GENERATION OF PROXIMITY INFORMATION”, filed Jan. 13, 2012, which is incorporated by reference for all purposes.

### BACKGROUND

Vehicles use a multitude of different monitoring devices to provide information regarding driving events. Examples of driving events include information relating to vehicle speed, engine emissions, vehicle location, and so forth. Examples of monitoring devices could include global positioning systems, accelerometers, temperature gauges, and many other monitoring devices. As information from each monitoring device is collected, further information into driving events may be acquired.

In particular, vehicles can be equipped with devices capable of monitoring vehicle location, speed, and other information. Vehicle location can be provided through the global position system through the use of a satellite navigation system. Information concerning vehicle location is useful in a number of applications including locating a place of interest, determining a vehicle's direction of movement, indicating proximity to other vehicles and object, and other information.

### OVERVIEW

Provided herein are methods and systems for generating and indicating proximity information. The method includes receiving and processing vehicle location information and generating vehicle proximity information based on the vehicle location information.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several implementations are described in connection with these drawings, the disclosure is not limited to the implementations disclosed herein. On the contrary, the intent is to cover all alternatives, modifications, and equivalents.

FIG. 1 illustrates communication between vehicles and server in an implementation, according to an example.

FIG. 2 illustrates graphical user interface reporting vehicle and object location in an example implementation.

FIG. 3 illustrates an operational flow diagram of an implementation, according to an example.

FIG. 4 illustrates an example server in an implementation.

### DETAILED DESCRIPTION

Implementations described herein allow individuals to determine the location of a vehicle in proximity to other vehicles, objects, pieces of equipment, and others. In particular, the driver of a vehicle is alerted when a potential collision is likely to occur with another vehicle or object. Additionally, various other types of vehicle proximity information may be reported including safety performance of a driver, location of other pieces of equipment, location and speed of the vehicle, and other information.

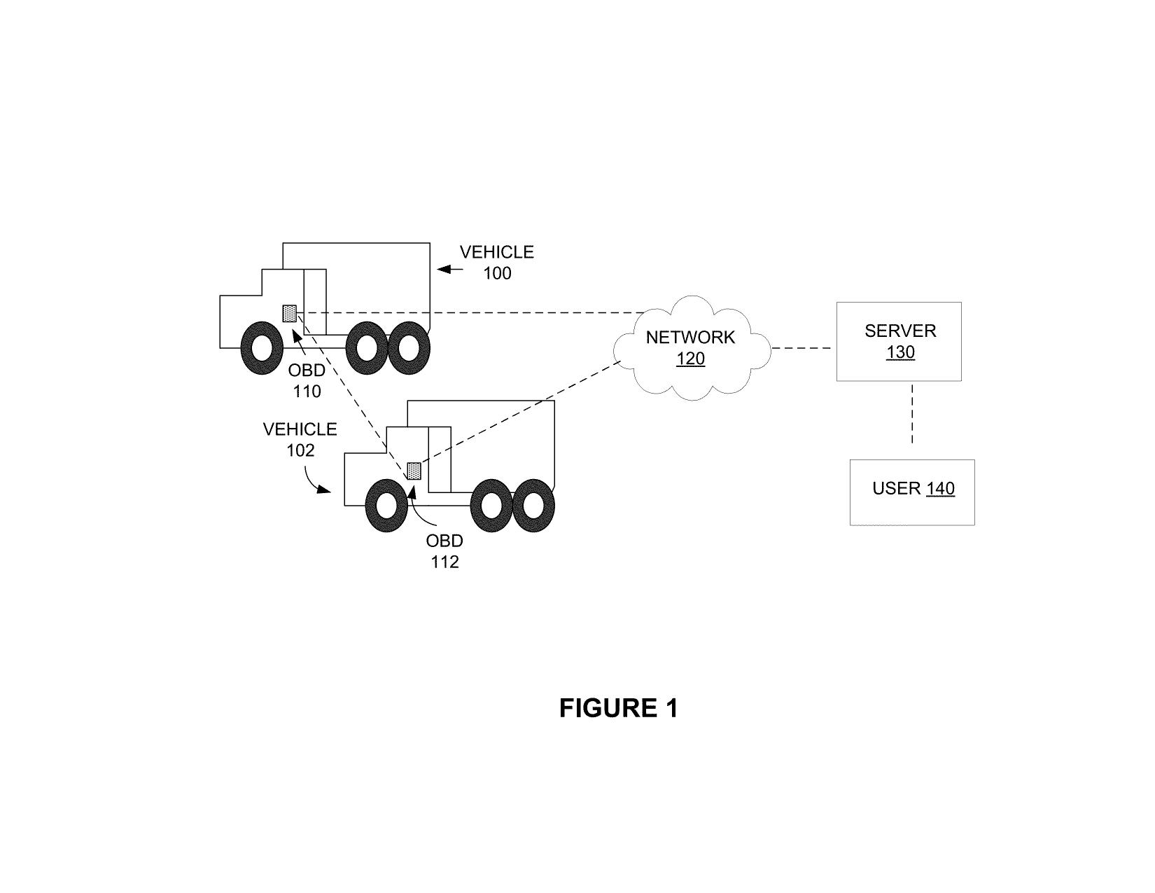

FIG. 1 illustrates communication between vehicles 100 and 102 and server 130. FIG. 1 includes vehicles 100 and 102, on-board devices (OBD) 110 and 112, network 120, and server 130. As shown, OBDs 110, 112 are capable of communicating with server 130 and each other via network 120 and/or any other method or system. Server 130 is further capable of communicating with user 140.

Additionally, OBDs 110, 112 may communicate between themselves. OBDs 110, 112 may communicate vehicle location and other information to each other and to server 130. The vehicle information may include location, speed, direction, acceleration, braking, and other information. OBDs 110, 112 may be linked to the vehicle's controller area network (CAN), and/or on-board diagnostics, and may be able to provide other information from the vehicle.

The vehicle information may be used, along with other data, to generate vehicle proximity information. Vehicle proximity information may include information from other vehicles and OBDs.

Vehicle proximity information may also include information about other objects and locations near the vehicle. The objects may include structures and other objects which may be damaged if vehicle hits them. Locations may include holes or other locations which may be damaged, or damage, the vehicle if the vehicle moves near them.

Vehicles 100 and 112 comprise pieces of equipment such as mining trucks, airplanes, tanks, cars, and the like. OBDs 110 and 112 comprise devices capable of receiving and transmitting location information such as GPS, smart phones, and any other device or system capable of operating as described herein. Network 120 comprises a collection of hardware components interconnected by communication channels that allow sharing of information such as radio networks, satellite networks, internet, and any other device or system capable of communication as described herein.

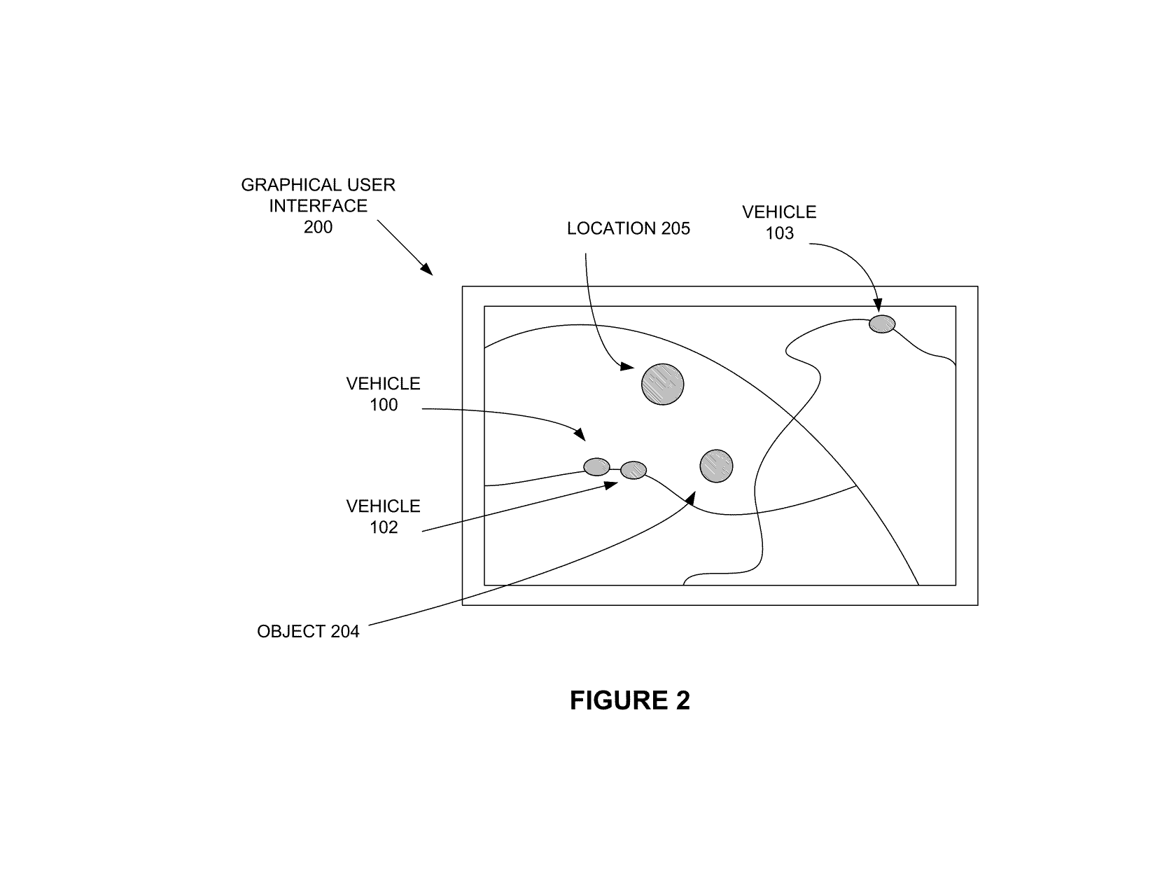

FIG. 2 illustrates graphical user interface (GUI) 200 displaying vehicle location. GUI 200 displays the location of nearby vehicles 101, 102, 103, and another object 204 and location 205 in real-time on a moving map. GUI 200 may be displayed locally to the vehicle, remotely to another location, or to both locations simultaneously.

GUI 200 may also be capable of providing alerts when the vehicle gets near another vehicle, object and/or location. This alert could be communicated through GUI 200, cell phone, OBD, or any other device capable of warning a driver. The alert could be audible, visual, or both. Other threshold warnings could also be incorporated alone or in combination into the implementation, including vehicle speed, past driver behavior, direction of motion, and any other factor influencing potential collision detection.

GUI 200 comprises any interface capable of displaying vehicle locations in real-time such as a liquid crystal display, plasma display, any other display capable of operating as an interface.

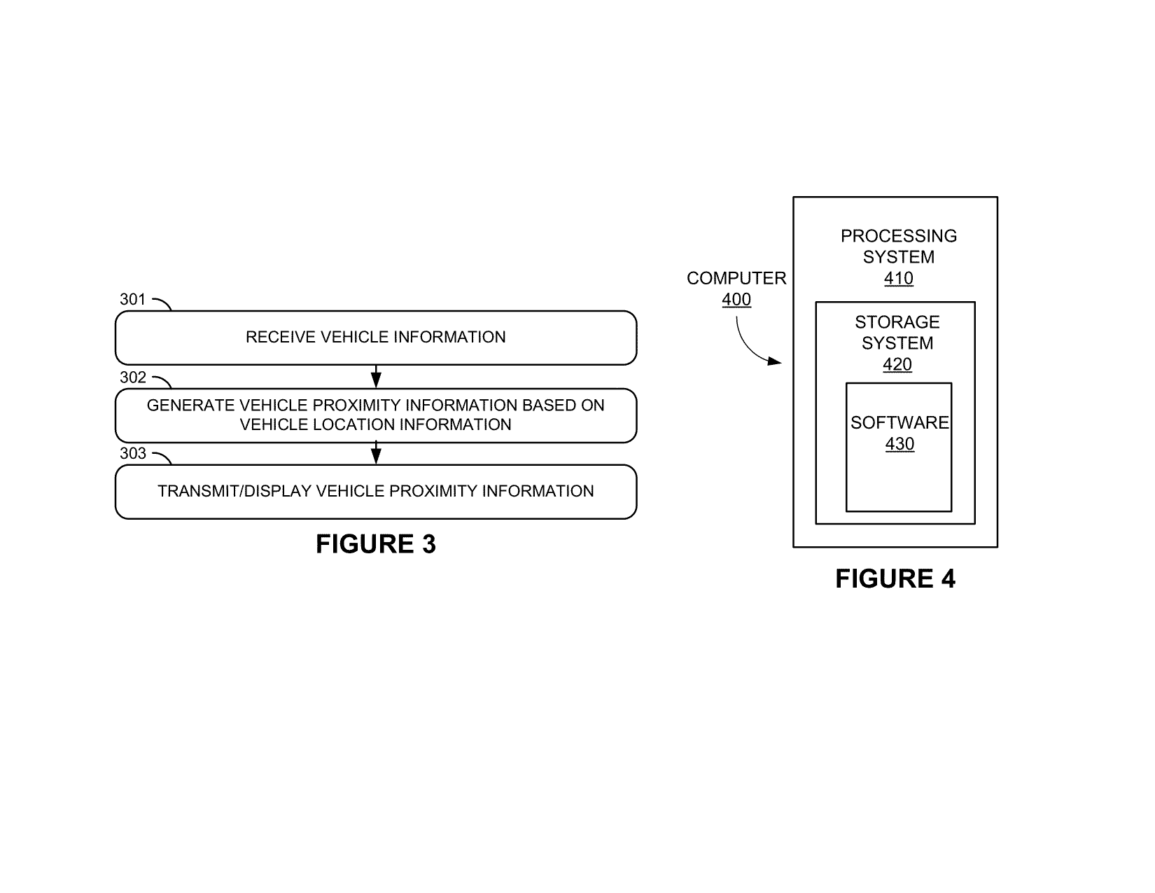

FIG. 3 illustrates an operational flow diagram. The steps of the operation are indicated below parenthetically. Vehicle 100 is equipped with OBD 110 which is capable of transmitting and receiving vehicle location information. OBD 110 transmits vehicle 100 location information via network 120 to server 130 or to other OBDs (301).

Server 130 and/or OBDs then generate vehicle proximity information based at least in part on the vehicle location information (302) received from OBDs 110, 112.

Vehicle proximity information may them be transmitted (303) to OBDs 110, 112, and displayed as shown in FIG. 2. Alerts may occur when a vehicle gets near other vehicles, objects, and/or locations. Near could be five feet, ten feet, or other distance.

In an implementation, server 130 and/or OBDs process vehicle 100 location information against vehicle 102 and/or object 204 location information to alert the driver of vehicle 100 of any potential collision between vehicle 100 and vehicle 102 and/or object 204 or location 205. In one implementation, GUI 200 could be used to display the location of all vehicles, objects, and/or locations within a specified area to assist in alerting the driver of vehicle 100 of any potential collision with other vehicles, objects, or locations.

In an example, vehicle 100 and vehicle 102 could be mining trucks. Vehicle 100 and vehicle 102 could both be equipped with OBD 110 and OBD 112, respectively. OBD 110 and OBD 112 would transmit their corresponding vehicle location to server 130 and/or other OBDs. In real-time, server 130 and/or OBDs would process the vehicle location and generate vehicle proximity information for use in the operation of vehicle 100 and vehicle 102.

In one implementation, vehicle 102 or object 204 may be located directly behind vehicle 100 which could lie in the blind spot of the driver of vehicle 100. In this situation server 130 would alert the driver of vehicle 100 of the potential collision with vehicle 102 through various means.

Through processing the location of vehicle 101 over time, server 130 may detect the motion of vehicle 100 as moving toward vehicle 102. Server 130 may then warn the drivers of vehicle 100 and vehicle 102 of a potential collision if the distance between the vehicles meets a certain threshold.

This alert could be communicated through GUI 200, cell phone, OBD, or any other device capable of warning a driver. The alert could be audible, visual, or both. Other threshold warnings could also be incorporated alone or in combination into the implementation, including vehicle speed, past driver behavior, direction of motion, and any other factor influencing potential collision detection. Furthermore, the server may allow the alarm to be turned off in the case where vehicle proximity information is unnecessary, for instance, where the driver can see behind the vehicle, or is working in an area where the alarm goes off too frequently.

Vehicle proximity information relating to the location of the vehicle may be sent to the vehicle, to the server, and/or to other OBDs. The information reported could include risk-weighted in-proximity vehicle lists to allow the drivers of the vehicles to better assess how to best avoid collisions.

The server 130 may be capable of sending out other information to user 140. The information reported could include the safety performance of every driver, and driving behavior, including vehicle speed. The information could be reported in a real-time operational dashboard that shows where every vehicle is, how it is being used, and where it has been.

The other information may be used to determine if certain drivers are and increased risk for accident or other incident based on speed, acceleration, braking, alerts, path, history, etc. Furthermore, the other information may be used to insure vehicles are in areas they are supposed to be in during working hours, etc. The information may also be used to determine is a vehicle is moving or being stolen during inactive hours.

FIG. 4 illustrates an example computing system 400 capable of operating as a server 130, user computer 140, and/or OBD. Computing system 400 includes processing system 410, storage system 420, and software 430.

Processing system 410 includes storage system 420. Processing system 410 retrieves and executes software 430 from storage system 420. In some examples, processing system 410 comprises specialized circuitry, and software 430 or storage system 420 could be included in the specialized circuitry to operate processing system 410 as described herein.

Storage system 420 could include a computer-readable medium such as a disk, tape, integrated circuit, server, or some other memory device, and also may be distributed among multiple memory devices.

Software 430 may include an operating system, logs, utilities, drivers, networking software, and other software typically loaded onto a computer system. Software 430 could contain an application program, firmware, or some other form of computer-readable processing instructions. When executed by processing system 410, software 430 directs processing system 410 to operate as described herein, such as receive vehicle location information, process vehicle location information, and generate vehicle proximity information.

It should be noted that the disclosure is in no way limited to the discussed implementations. The applicability of the present disclosure extends to many fields including aviation, construction, mining, and so forth. For instance, airline pilots operating an airplane on tarmac encounter various situations in which knowledge of the location of the airplane, other object, and/or locations in proximity to other airplanes is critical.

FIGS. 1-4 and the previous descriptions depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. These variations and features are intended to be included in the spirit and scope of this disclosure. As a result, this disclosure is not limited to the specific implementations described above, but only by the claims and their equivalents.

What is claimed is:

1. A method for generating vehicle proximity information, comprising:
receiving vehicle location information from a first vehicle by a server;
generating vehicle proximity information based at least in part on the vehicle location information by the server; and
transmitting the vehicle proximity information.

2. The method of claim 1, wherein the vehicle proximity information comprises location information from other vehicles, objects, and/or locations within a certain distance from the first vehicle.

3. The method of claim 2, further comprising transmitting an alert when the vehicle proximity information indicates proximity of the first vehicle to other vehicles, objects, and/or locations.

4. The method of claim 2, wherein objects comprise objects which would be damaged in a collision with the first vehicle.

5. The method of claim 4, wherein the objects comprise a marker, mine shaft, rig, and/or building.

6. The method of claim 1, wherein vehicle location information comprises, location, speed, and direction relating to the first vehicle.

7. The method of claim 1, wherein the generating comprises aggregating information relating to other vehicles, objects, and/or locations within proximity to the first vehicle.

8. The method of claim 1, wherein the transmitting comprises transmitting the vehicle proximity information to the first vehicle.

9. A non-transitory computer readable medium having stored thereon program instructions executable by a computing device that, when executed by the computing device, direct the computing device to:
receive vehicle location information from a first vehicle by a server;
generate vehicle proximity information based at least in part on the vehicle location information by the server; and
transmit the vehicle proximity information.

10. The non-transitory computer readable medium of claim 9, wherein the vehicle proximity information comprises location information from other vehicles, objects, and/or locations within a certain distance from the first vehicle.

11. The non-transitory computer readable medium of claim 10, further comprising transmitting an alert when the vehicle proximity information indicates proximity of the first vehicle to other vehicles, objects, and/or locations.

12. The non-transitory computer readable medium of claim 10, wherein objects comprise objects which would be damaged in a collision with the first vehicle.

13. The non-transitory computer readable medium of claim 12, wherein the objects comprise a marker, mine shaft, rig, and/or building.

14. The non-transitory computer readable medium of claim 9, wherein vehicle location information comprises, location, speed, and direction relating to the first vehicle.

15. The non-transitory computer readable medium of claim 9, wherein the generating comprises aggregating information relating to other vehicles, objects, and/or locations within proximity to the first vehicle.

16. The non-transitory computer readable medium of claim 9, wherein the transmitting comprises transmitting the vehicle proximity information to the first vehicle.

17. A method for generating vehicle proximity information, comprising:
receiving vehicle location information from a first vehicle by a on board device;
generating vehicle proximity information based at least in part on the vehicle location information by the on board device; and
transmitting the vehicle proximity information.

18. The method of claim 17, wherein the vehicle proximity information comprises location information from other vehicles, objects, and/or locations within a certain distance from the first vehicle.

19. The method of claim 18, further comprising transmitting an alert when the vehicle proximity information indicates proximity of the first vehicle to other vehicles, objects, and/or locations.

20. The method of claim 17, wherein the generating comprises aggregating information relating to other vehicles, objects, and/or locations within proximity to the first vehicle, and the transmitting comprises transmitting the vehicle proximity information to other on board devices.
